(19) United States
(12) Patent Application Publication
(10) Pub. No.: US 2007/0255575 A1
(43) Pub. Date: Nov. 1, 2007

(54) PRODUCT REGISTRATION REDUNDANCY ELIMINATION

(76) Inventor: Brian K. Buchheit, Davie, FL (US)

Correspondence Address: PATENTS ON DEMAND, P.A., 4581 WESTON ROAD, SUITE 345, WESTON, FL, 33331, US

(21) Appl. No.: 11/380,527

(22) Filed: Apr. 27, 2006

(51) Int. Cl. G06Q 10/00; G06Q 30/00

(52) U.S. Cl. 705/1

(57) ABSTRACT

A method for registering products can include a step of identifying at least one product associated with a consumer purchase. Consumer purchase information can be received as part of the consumer purchase. A product registration associated with the product can be automatically determined. At least a portion of the product registration can be automatically completed using the consumer purchase information. The product can be registered using the automatically completed product registration.

### BACKGROUND

1. Field of the Invention

The present invention relates to the field of product registration and more particularly to a novel system of product registration redundancy elimination.

2. Description of the Related Art

When a consumer purchases a product from a seller, he or she is often asked for identification information including name, phone number, address, date of birth, and e-mail address. This information is primarily used by the seller to better understand demographics of their patrons and to determine which products to keep in stock and the quantities in which to do so.

Oftentimes, in order to receive the full benefits of a product they have purchased, consumers must also provide the same identification information, along with purchased product information and additional consumer information (if required and/or requested by a producer), to a producer in a process called product registration. Product registration provides the producer with valuable demographic information about consumers of their products. They use this information to target who their audience is, to produce new products of interest for that audience, and to better market their existing products. To coax consumers into performing this tedious task, producers will often reserve special benefits for those who complete registration. Also, some producers will only provide support to those customers that have registered their products.

A common example of an incentive used by producers to sway consumers to register a product is making registration of the purchased product mandatory prior to activation of a warranty. In other cases, as opposed to presenting a sales receipt to a service technician upon encountering problems with a product, a consumer can register the product prior to experiencing difficulties. Registration can serve as proof of purchase when problems encountered with the product make customer support necessary. Other examples of benefits include: updates for a product, special promotions, facilitated customer support, an opportunity to participate in a community of other consumers of products by the same producer, free material, and entry into drawings for monetary and other prizes.

In today's rapidly changing marketplace increasing importance is being placed on the role of product registration, especially within the realm of e-commerce. In spite of this growing importance, the redundancy of providing what can be identical consumer identification information numerous times still exists. This needless expenditure of time can be frustrating to consumers and can result in otherwise willing consumers not registering purchased products, thereby resulting in a surrender of potential product registration benefits.

### SUMMARY OF THE INVENTION

The present invention discloses a system to eliminate product registration redundancy in accordance with an embodiment of the inventive arrangements disclosed herein. Using the invention, a consumer can eliminate the need to provide consumer identification information to both a seller of a purchased product and a producer of the purchased product separately. Oftentimes, the only supplementary information that is needed to complete product registration is product information, such as product number, model number, serial number, and date of purchase. Usually, this information can easily be obtained by a seller, as sellers typically store this type of information to track sales and inventory. If additional information is required of a consumer by a producer to complete product registration, this information can be requested by a seller.

In one embodiment, a consumer can purchase one or more products from a seller. The consumer can provide identification information to the seller. The seller can request authorization to register the products with producers of the products. If the consumer provides authorization, the seller may request additional consumer information, if the information is requested and/or required by the producers to complete product registration. The seller can transmit consumer identification information, product information, and additional consumer information (if required and/or requested) to the producers of the purchased products directly or through a product registration facilitator. Once the purchased products have been registered, the consumer may be eligible for associated benefits.

In one embodiment, a consumer can purchase one or more products, with the use of a consumer client device, from a seller, using a seller server system, through a network such as the Internet. Purchased products can be shipped to the consumer via a third party company. In such a commercial transaction, which is commonly referred to as e-commerce, the consumer may be required to provide the seller with identification information. The consumer can be prompted to register products purchased using the submitted identification information. If authorization is given, the consumer may be prompted for additional consumer information based on requirements and/or requests of producers of the products. The seller can transmit required registration information to the producers via producer server systems. Registration information may also be provided to associated registration data stores. Upon registration of purchased products, consumers may be eligible for associated benefits. The consumer can optionally receive a registration notification through e-mail.

The present invention can be implemented in accordance with numerous aspects consistent with material presented herein. For example, one aspect of the present invention can include a method for registering products that includes a step of identifying at least one product associated with a consumer purchase. Consumer purchase information can be received as part of the consumer purchase. A product registration associated with the product can be automatically determined. At least a portion of the product registration can be automatically completed using the consumer purchase information. The product can be registered using the automatically completed product registration.

Another aspect of the present invention can include a method to purchase and register digital media content. The method can include a step of identifying a request by a consumer to purchase media containing digital media content or to purchase a downloadable copy of the digital media content. Consumer purchase information can be obtained at a time of sale associated with the consumer request. The digital media content can be registered using the consumer purchase information. Registering the digital media content can permit the consumer to legally acquire another copy of the digital media content at a cost less than a normal commercial cost.

Still another aspect of the present invention can include a method for selling and registering products. The method can include a step of recording within a machine readable storage specifics of a consumer purchase. The recording step can be performed by a seller's computing system to account for the consumer purchase. Consumer identification information associated with the consumer purchase can be stored within a data store accessible by the seller's computing system. The seller's computing system can utilize the specifics of the consumer purchase and the consumer identification information to register at least one product included in the consumer purchase with a remotely located registration computing system on behalf of the consumer.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a flow diagram of a system where product registration redundancy can be eliminated in accordance with an embodiment of the inventive arrangements contained herein.

FIG. 2 is a schematic diagram of a system that uses digital transfer of information required to complete product registration to eliminate product registration redundancy in accordance with an embodiment of the inventive arrangements contained herein.

FIG. 3 is a schematic diagram of a system where digital media content can be transferred to various media and portable devices, through a consumer client device from a producer server system and/or a digitally encoded media source, subsequent to product registration of a purchased media product in accordance with an embodiment of the inventive arrangements contained herein.

FIG. 4 is a flow chart of a method where product registration redundancy can be eliminated in accordance with an embodiment of the inventive arrangements disclosed herein.

### DETAILED DESCRIPTION OF THE INVENTION

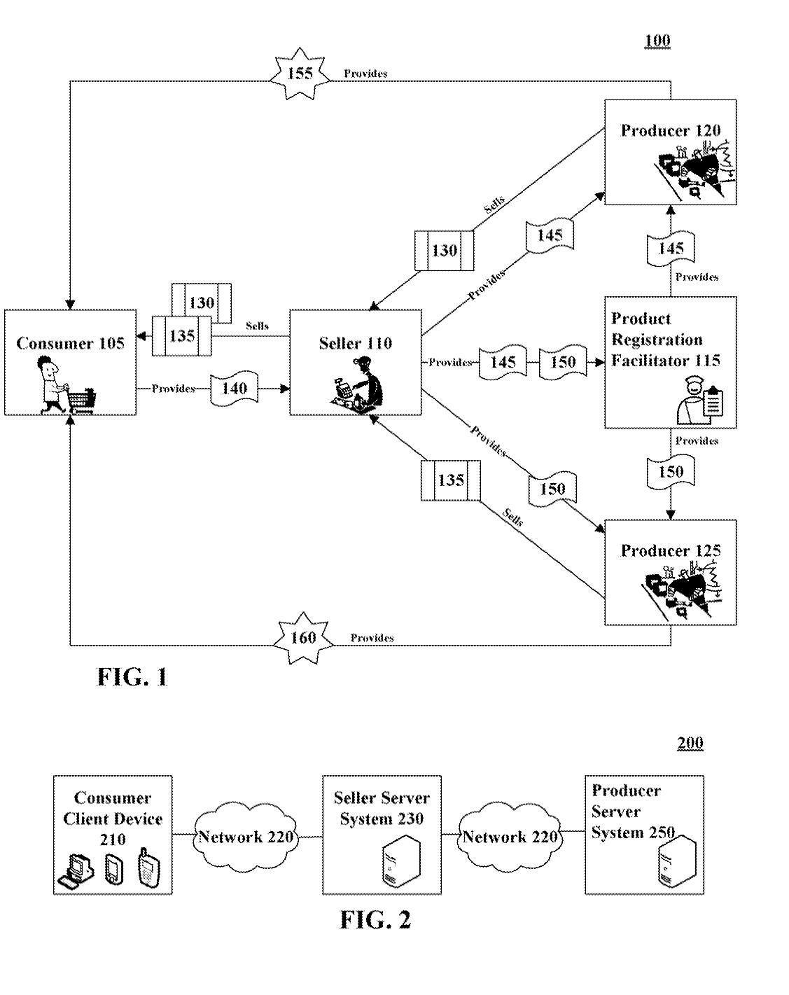

FIG. 1 is a flow diagram of a system 100 where product registration redundancy can be eliminated in accordance with an embodiment of the inventive arrangements contained herein. In system 100, producers 120 and 125 can sell products 130 and 135 to a seller 110. Seller 110 can sell products 130 and 135 to a consumer 105.

Consumer 105 may be asked to provide consumer identification information 140 to seller 110. Upon receiving authorization from consumer 105, seller 110 can provide product registration information 145 and 150 to producers 120 and 125, either directly or through a product registration facilitator 115, to register the purchased products 130 and 135.

After products 130 and 135, purchased by consumer 105, are registered with producers 120 and 125, producers 120 and 125 can provide product registration benefits 155 and 160 to consumer 105.

Consumer 105 can refer to any person or entity that is the purchaser of products 130 and 135 from seller 110. For example, consumer 105 can be a private citizen who purchases products 130 and 135 from seller 110 for his or her own personal use. Consumer 105 can register these products with producers 120 and 125 to receive the full benefits 155 and 160 of registration that are contingent upon ownership.

In another example, consumer 105 can refer to a business entity that purchases products 130 and 135 from seller 110 for use within a business environment. Consumer 105, in this example, can register the purchased products to receive benefits 155 and 160 as well, but may make use of these benefits in a different capacity as may be more useful in a business context.

Seller 110 can refer to any intermediary entity that purchases products 130 and 135 from producers 120 and 125 to sell to consumer 105. For example, seller 110 can be a retail outlet that purchases products 130 and 135 directly from producers 120 and 125, or through an intermediary such as a wholesaler. In another example, seller 110 can be a wholesaler that purchases products 130 and 135 from producers 120 and 125 and sells these products directly to consumer 105. The inventive arrangements disclosed herein are contemplated with regards to both scenarios but are not limited in application to either.

Producers 120 and 125 can refer to business entities that produce products 130 and 135 which are ultimately sold to consumer 105, possibly through seller 110. Producers 120 and 125 are responsible for providing benefits 155 and 160 in exchange for registration of products 130 and 135 in accordance with guarantees made by producers 120 and 125.

Product registration facilitator 115 can refer to a business entity that aids in set up and execution of the inventive arrangements disclosed herein between seller 110 and producers 120 and 125. The service provided by product registration facilitator 115 can include the set up of a system including one or more interfaces between seller 110 and producers 120 and 125.

In one embodiment, product registration facilitator 115 can arrange a system in which product registration information 145 and 150 can be transmitted from seller 110 to producers 120 and 125 without the need for any intermediary personnel. For example, product registration facilitator 115 can arrange a system in which a network is set up connecting computers used by seller 110 and producer 120. Information entered by seller 110 on a computing device can be electronically transmitted to producer 120. A similar network can be set up between seller 110 and producer 125 as well. One network that is contemplated includes the Internet.

In another embodiment, product registration facilitator 115 can arrange a system in which product registration information 145 and 150 is provided from a seller 110 to a product registration facilitator 115. The facilitator 115 can provide the product registration information 145 and 150 to producers 120 and 125.

For example, product registration information 145 and 150 can be provided to a product registration facilitator 115 through a variety of means including, among others, a telephone device, such as a phone or fax, and/or a computer device. The product registration information 145 and 150 can be processed and provided to producers 120 and 125 or made available to producers 120 and 125 through storage of information 145 and 150 in a registration data store that can be operated by product registration facilitator 115.

The role of product registration facilitator 115 is not, however, to be limited to only the two embodiments presented above. All embodiments are contemplated with regards to achieving fulfillment of a role assigned to product registration facilitator 115.

Products 130 and 135 can refer to items that are produced by producers 120 and 125 for sale to seller 110 and ultimately to consumer 105. Consumer identification information 140 can include information that is used by seller 110 to track demographics of its clients. For example, information requested can include name, phone number, address, date of birth, and e-mail address. Consumer identification information 140 requested varies from seller to seller. However, more comprehensive consumer identification information 140 is generally required for enrollment in membership plans that can be made available to consumers.

Product registration information 145 and 150 can refer to information that is required by producers 120 and 125 to register products 130 and 135. Product registration information can consist of consumer identification information 140, product information about products 130 and 135, and additional consumer information as required and/or requested by producers 120 and 125.

Product information about products 130 and 135 can include information such as product number, serial number, model number and date of purchase. This information is usually easily available to sellers as sellers typically store this type of information to track sales and inventory. For example, bar codes which are now widely employed, such as UPC codes, can be used to identify the producer and product code of a product.

Additional consumer information can refer to supplementary information that is required and/or requested by producers 120/125 to complete product registration of products 130/135. In an embodiment, additional consumer information required and/or requested by producers to complete product registration can be made uniform by a third party, such as a product registration facilitator 115. Uniformity can decrease expenditure of time by consumer 105 by allowing the ability to register multiple products concurrently.

Product registration benefits 155 and 160 can refer to benefits provided by producers 120 and 125 to consumer 105 in exchange for registration or products 130 and 135. Example of product registration benefits can include: updates related to a product purchased, special promotions, an opportunity to participate in a community of other purchasers of products by the same producer, free material, and entry into drawings for monetary and other prizes. Although not represented in system 100, examples of other incentives used to coax consumer 105 into registering purchased products 130 and 135 can include activation of a warranty and/or more comprehensive customer support.

FIG. 2 is a schematic diagram of a system 200 that uses digital transfer of information required to complete product registration to eliminate product registration redundancy in accordance with an embodiment of the inventive arrangements contained herein. In one embodiment, components detailed in system 200 can be how components in system 100 would operate in an e-commerce environment. For example, consumer client device 210 can represent the method by which consumer 105 purchases products 130 and 135.

System 200 can include consumer client device 210, seller server system 230, and producer server system 250, which are communicatively linked through network 220.

Consumer client device 210 can be a computing device configured to interface with seller server system 230. The consumer client device 210 can include a device that communicates over a data network. The consumer client device 210 can include a computer, a tablet PC, a personal data assistant (PDA), a smart phone, and other such devices.

Seller server system 230 can be a computer system that handles requests for data, e-mail transfers, and other network services from other computers. Seller server system 230 can be configured to interface with consumer client device 210 and producer server system 250 via network 220. In an embodiment where components of system 200 are utilized by components of system 100, consumer 105 can purchase products 130 and 135, utilizing consumer client device 210, from seller 110, utilizing seller server system 230. Consumer 105 can provide consumer identification information 140, utilizing consumer client device 210, to seller 110, utilizing seller server system 230.

Producer server system 250 can be a computer system that handles requests for data, e-mail, file transfers, and other network services from other computers. Producer server system 250 can be configured to interface with seller server system 230 via network 220.

Network 220 can refer to a means by which data is transmitted between consumer client device 210 and seller server system 230 and between seller server system 230 and producer server system 250. Network 220 can include any hardware, software, and firmware necessary to convey data encoded within carrier waves. Data can be contained within analog or digital signals and conveyed though data or voice channels. Network 220 can include local components and data pathways necessary for communications to be exchanged among computing device components and between integrated device components and peripheral devices. Network 220 can also include network equipment, such as routers, data lines, hubs, and intermediary servers which together form a data network, such as the Internet.

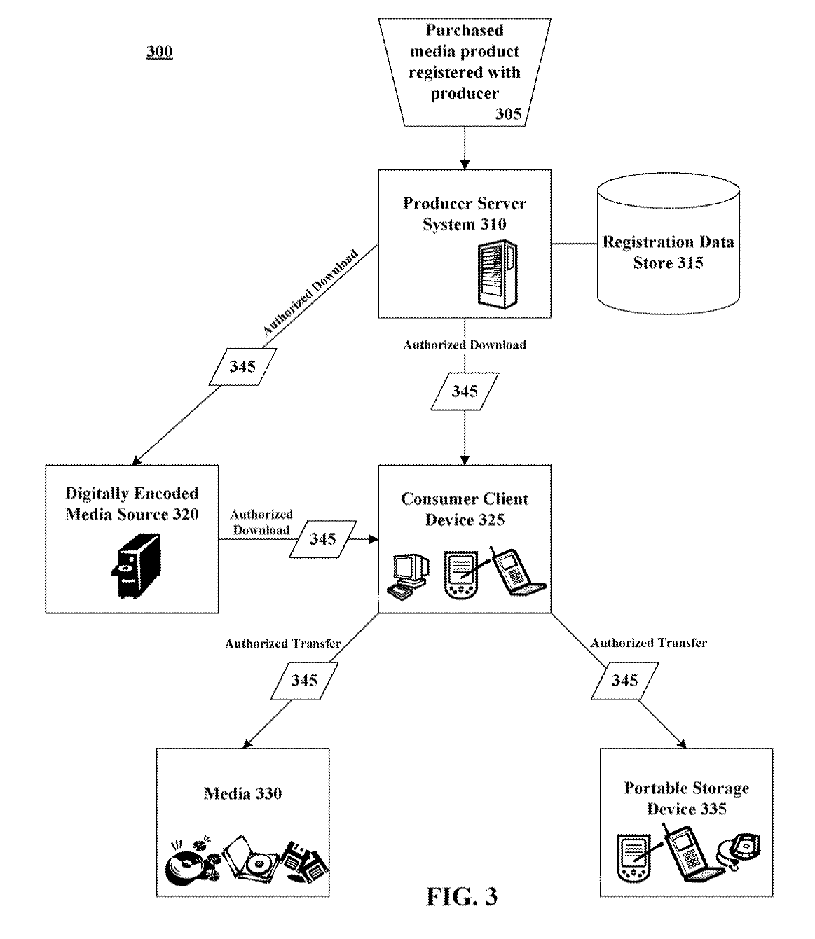

FIG. 3 is a schematic diagram of a system 300 where digital media content can be transferred to various media and portable devices, through a consumer client device from a producer server system and/or a digitally encoded media source, subsequent to product registration of a purchased media product in accordance with an embodiment of the inventive arrangements contained herein.

Upon registration of a purchased media product 305, a producer can permit an authorized download of digital media content 345 from producer server system 310, directly to consumer client device 325 and/or via a digitally encoded media source 320. Media content 345 can be transferred to media 330 and/or portable storage device 335. In an embodiment, authorized download and/or transfer of media content 345 can occur at no additional cost or at a reduced cost.

For example, after a consumer has purchased a media product from a seller and it has been registered, the consumer can download and transfer the digital media content 345 to other media 330, possibly different from the original purchased product media, and/or a portable storage device 335 at no additional cost or at a reduced cost.

Producer server system 310 can be a computer system that handles requests for data, e-mail, file transfers, and other network services from other computers. Producer server system 310 can be configured to interface with consumer client device 325 via a network by which an authorized download of digital media content 345 can occur. Registration data store 315 can be a physical or virtual storage space configured to store digital information. Registration data store 315 can be configured to store product registration information.

Digitally encoded media source 320 can be an intermediary computer system through which an authorized download of digital media content 345 can be received by consumer client device 325. In an embodiment, digitally encoded media source 320 can provide a conveniently centralized location from which a consumer can download various digital media content, produced by a number of different producers, subsequent to registration of associated purchased media products. For example, after a consumer purchases and registers a music CD, he or she can download the digital media content to client device 325.

Consumer client device 325 can be a computing device configured to interface with producer server system 310, media 330, and portable storage device 335 via a network through which an authorized download and/or transfer of digital media content 345 can occur. Client device 325 can include a device that communicates over a data network. Client device 325 can include a computer, a tablet PC, a personal data assistant (PDA), a smart phone, and other such devices.

Media 330 can refer to media onto which an authorized transfer of digital media content 345 can occur subsequent to registration of the associated purchased media product. Examples of media can include CD's, DVD's, diskettes, and UMD's (Universal Media Discs).

Portable storage device 335 can refer to a device which can conveniently be carried about and is capable of storing digital data. Portable storage device 335 can refer to a device onto which an authorized transfer of digital media content 345 can occur subsequent to registration of the associated purchased media product. Examples of portable storage devices can include personal data assistants, smart phones, and portable digital audio players.

Digital media content 345 can refer to information that is stored on media through the use of distinct electronic or optical pulses that represent the binary digits 0 and 1. Digital media content 345 can be downloaded to a consumer client device 325 and transferred to media 330 and portable storage device 335 subsequent to registration of a purchased media product.

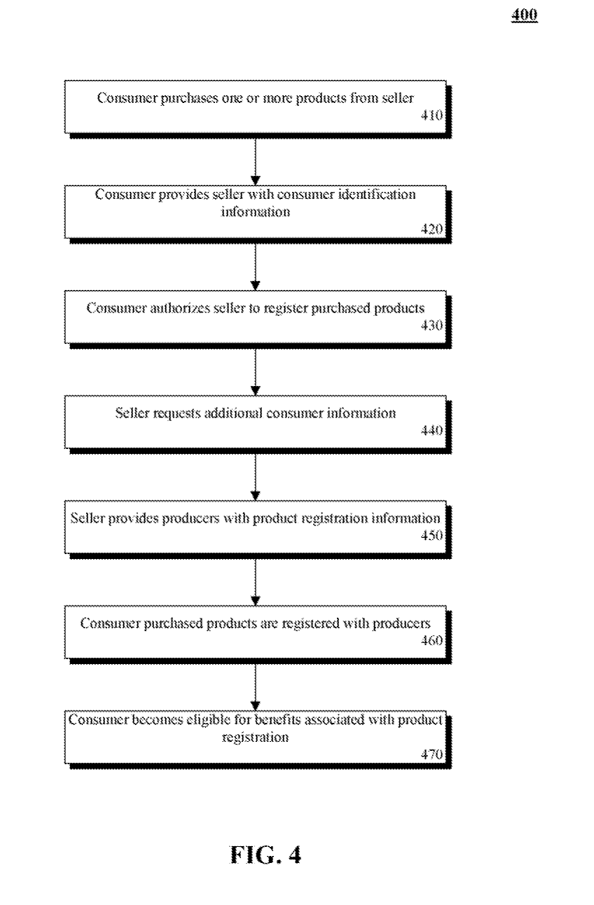

FIG. 4 is a flow chart of a method 400 where product registration redundancy can be eliminated in accordance with an embodiment of the inventive arrangements disclosed herein. Method 400 can be performed in the context of any product registration redundancy elimination system, such as system 100 or system 200.

Method 400 can begin in step 410, where a consumer purchases one or more products from a seller. The seller can request consumer identification information from the consumer if the information is not already in the possession of the seller. The seller may already have this information if the consumer has purchased products from the seller before and/or has enrolled in a membership plan. In step 420, the consumer provides the seller with consumer identification information.

In step 430, the consumer authorizes the seller to register the purchased products. In optional step 440, the seller may request additional consumer information. This information may be sought to complete product registration, based on the requirements and/or requests of producers of purchased products that are not met from consumer identification information already provided to the seller. Consumer identification information required and/or requested by different sellers may vary.

In step 450, the seller provides producers with product registration information. Product registration information can consist of consumer identification information, product information, and additional consumer information (should it be required and/or requested by producers). This step can be carried out directly between the seller and producers and/or through an intermediary such as a product registration facilitator.

In step 460, purchased products are registered with producers. In step 470, the consumer becomes eligible for benefits associated with product registration. Some benefits may be provided automatically upon registration, such as activation of a warranty or entry into a drawing for monetary and other prizes. Other benefits may need to be sought after becoming eligible for them, such as more comprehensive customer support and product updates.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for registering products comprising:
identifying at least one product associated with a consumer purchase;
receiving consumer purchase information as part of the consumer purchase;
automatically determining a product registration associated with the product;
automatically completing at least a portion of the product registration using the consumer purchase information; and
registering the product using the automatically completed product registration.

2. The method of claim 1, further comprising:
obtaining additional product registration information from a consumer after the completing step and before the registering step.

3. The method of claim 1, wherein the consumer purchase comprises a plurality of products, each having a product specific registration; the method further comprising:
determining those data fields required for each product specific registration that have no equivalent fields within the consumer purchase information;
combining corresponding data fields from different product registrations that require information into a common data field;
querying a consumer for common fields; and
automatically completing each product specific registration based upon results from the querying step and based upon the consumer purchase information.

4. The method of claim 1, further comprising:
completing a purchase of the product at a storefront channel of commerce; and
wherein the determining and completing steps are performed by a storefront computing device at a time of sale.

5. The method of claim 4, wherein the consumer purchase includes a plurality of products, each having a product specific registration, wherein determining, completing, and registering steps are automatically performed by the storefront computing device for each of the plurality of products at the time of sale.

6. The method of claim 1, further comprising:
completing a purchase of the product via an e-commerce Web site, wherein the determining and completing steps are automatically performed at a time of sale.

7. The method of claim 1, wherein the product includes digital media content, the method further comprising:
after the registering step, receiving a request from a consumer that registered the product to download the digital media content; and
permitting the consumer to legally download another copy of the digital media content at a cost less than a normal commercial cost.

8. The method of claim 7, wherein a format of the digital media content for which a download is permitted is different than a format associated with the consumer purchase.

9. The method of claim 7, wherein the download copy has a different fidelity than a fidelity of digital media content associated with the consumer purchase.

10. The method of claim 1, wherein said steps of claim 1 are performed by at least one machine in accordance with at least one computer program having a plurality of code sections that are executable by the at least one machine.

11. A method to purchase and register digital media content comprising:
identifying a request by a consumer to purchase at least one of media containing digital media content and a download of digital media content;
obtaining consumer purchase information at a time of sale associated with the consumer request; and
registering the digital media content using the consumer purchase information, wherein registering the digital media content permits the consumer to legally acquire another copy of the digital media content at a cost less than a normal commercial cost.

12. The method of claim 11, wherein the registering of the digital media content permits the consumer to download another copy of the digital media content for at least one of a nominal cost and free.

13. The method of claim 11, wherein digital rights management code included within the digital media content prevents multiple copies of the digital media content to be utilized at any one time.

14. The method of claim 11, wherein the registering step is performed at least one of a seller of the digital media content and a computing device utilized by the seller.

15. The method of claim 11, wherein a format of the another copy of the digital media content is different than a format of the digital media content associated with an original consumer purchase.

16. The method of claim 11, wherein a format of the another copy of the digital media content has a different fidelity than a fidelity of digital media content associated with an original consumer purchase.

17. The method of claim 11, wherein the consumer originally purchases physical media containing the digital media content, and wherein the another copy of the digital media is downloadable by the consumer via a Web site.

18. The method of claim 17, wherein the digital media comprises at least one of a set of songs and a movie.

19. A method for selling and registering products comprising:
recording within a machine readable storage specifics of a consumer purchase, wherein the recording step is performed by a seller's computing system to account for the consumer purchase;
storing consumer identification information associated with the consumer purchase within a data store accessible by the seller's computing system; and
the seller's computing system utilizing the specifics of the consumer purchase and the consumer identification information to register at least one product included in the consumer purchase with a remotely located registration computing system on behalf of the consumer.

20. The product includes at least one of media containing digital media content and a download of digital media content, wherein the digital media content includes at least one of a software product, a song, and a movie, and wherein registration of the digital media content permits the consumer to legally download another copy of the digital media content for at least one of a nominal cost and free.
